(19) United States
(12) Patent Application Publication
(10) Pub. No.: US 2026/0203101 A1
(43) Pub. Date: Jul. 16, 2026

(54) SYSTEMS AND METHODS FOR CONTEXT-AWARE ARTIFICIAL INTELLIGENCE WORKLOAD DEPLOYMENT OPTIMIZATION

(71) Applicant: Dell Products L.P., Round Rock, TX (US)

(72) Inventors: Robert C. HERNANDEZ, Morrisville, NC (US); Ryan N. COMER, Round Rock, TX (US); Jake M. LELAND, Round Rock, TX (US)

(73) Assignee: Dell Products L.P., Round Rock, TX (US)

(21) Appl. No.: 19/020,328

(22) Filed: Jan. 14, 2025

(51) Int. Cl. G06F 9/48; G06F 11/34

(52) U.S. Cl. CPC G06F 9/4881; G06F 11/34

(57) ABSTRACT

An information handling system may include a memory and a processor communicatively coupled to the memory, and configured to collect contextual information associated with a first artificial intelligence model executing on a compute node and execute a second artificial intelligence model to generate a new model deployment suggestion inference for the first artificial intelligence model based at least on the contextual information, the new model deployment suggestion inference setting forth parameters for a redeployment of the first artificial intelligence model.

### TECHNICAL FIELD

The present disclosure relates in general to information handling systems, and more particularly to systems and methods for detecting opportunities to optimize artificial intelligence workloads across compute nodes.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

As advancements in artificial intelligence infrastructure continue to enable more client-friendly form factors, artificial intelligence model deployments are rapidly diversifying from cloud computing environments to edge computing environments. Artificial intelligence-enabled enterprises have increasingly more freedom to choose where their workloads run, often selecting local and edge deployments for the sake of cost and data protection. However, edge environments present unique challenges.

Artificial intelligence models are challenging to manage because of the amount of compute resources they require. Optimization techniques like speculative decoding, using smaller models, model quantization, or other techniques can be deployed, but existing approaches do not provide mechanisms to alert information technology decision makers of when such optimization techniques should be used.

### SUMMARY

In accordance with the teachings of the present disclosure, the disadvantages and problems associated with existing approaches to deployment of artificial intelligence workloads may be reduced or eliminated.

In accordance with embodiments of the present disclosure, an information handling system may include a memory and a processor communicatively coupled to the memory, and configured to collect contextual information associated with a first artificial intelligence model executing on a compute node and execute a second artificial intelligence model to generate a new model deployment suggestion inference for the first artificial intelligence model based at least on the contextual information, the new model deployment suggestion inference setting forth parameters for a redeployment of the first artificial intelligence model.

In accordance with these and other embodiments of the present disclosure, a method may include collecting contextual information associated with a first artificial intelligence model executing on a compute node and executing a second artificial intelligence model to generate a new model deployment suggestion inference for the first artificial intelligence model based at least on the contextual information, the new model deployment suggestion inference setting forth parameters for a redeployment of the first artificial intelligence model.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to collect contextual information associated with a first artificial intelligence model executing on a compute node and execute a second artificial intelligence model to generate a new model deployment suggestion inference for the first artificial intelligence model based at least on the contextual information, the new model deployment suggestion inference setting forth parameters for a redeployment of the first artificial intelligence model.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure;

FIG. 2 illustrates a flow chart of an example method for context-aware artificial intelligence workload deployment, in accordance with embodiments of the present disclosure;

FIG. 3 illustrates a timing diagram of an example allocation of memory footprints of artificial intelligence workloads across three compute nodes, in accordance with embodiments of the present disclosure;

FIG. 4 illustrates another timing diagram of an example allocation of memory footprints of artificial intelligence workloads across three compute nodes, in accordance with embodiments of the present disclosure;

FIGS. 5A and 5B (which may be referred to herein collectively as “FIG. 5”) illustrate yet another timing diagram of an example allocation of memory footprints of artificial intelligence workloads across three compute nodes, in accordance with embodiments of the present disclosure; and

FIG. 6 illustrates yet another diagram of an example allocation of memory footprints of artificial intelligence workloads across three compute nodes, in accordance with embodiments of the present disclosure.

### DETAILED DESCRIPTION

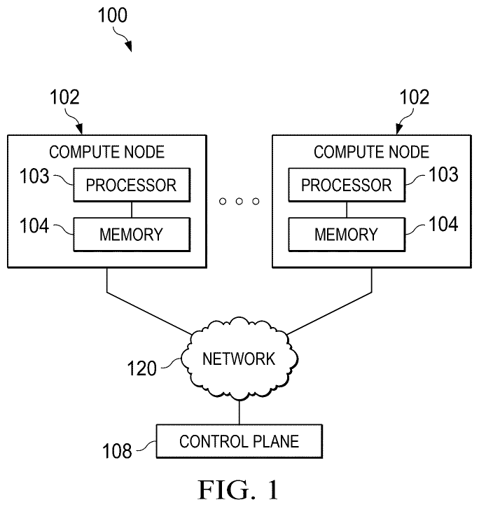

Preferred embodiments and their advantages are best understood by reference to FIGS. 1 through 6, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for assisting the placement of artificial intelligence workloads for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may combine classic metrics (processor types, memory, disk, latency) with an orchestration approach that is aware of a context of system 100, including added dimensions of model sizes, silicon architecture, user feedback, execution context, and other contextual parameters, in order to optimize deployment of artificial intelligence model workloads. For example, when compute nodes 102 begin to reach the limits of their capacity, control plane 108 may use a trained artificial intelligence model to generate model deployment suggestions, in order to redeploy models of smaller sizes until the load decreases, at which point the original model size may be redeployed. If smaller models are not available, control plane 108 may schedule tasks to perform quantization during times of lower utility, thus making the smaller models available in the future.

For example, control plane 108 may receive artificial intelligence model configuration parameters, operation context parameters, system telemetry, and model telemetry and based thereon, determine per-instance model inferences.

Artificial intelligence model configuration parameters may include, without limitation, the artificial intelligence models loaded on compute nodes 102, quantization levels of the artificial intelligence models, latency requirements of the artificial intelligence models, and accuracy requirements of the artificial intelligence models. Operation context parameters may include, without limitation, user actions, application interactions within system 100, content of user prompts and/or responses from artificial intelligence models, system platforms of compute nodes 102 (e.g., silicon architecture), inter-user interaction, environment, user feedback, and other context parameters. System telemetry may include telemetry data for compute nodes 102, such as compute load, compute capacity, available compute nodes, and/or other data.

Model telemetry may include, without limitation, model accuracy data or model accuracy score (e.g., as set forth in U.S. patent application Ser. No. 19/020,069, filed on Jan. 14, 2025, which is incorporated by reference herein in its entirety) and/or power recommendations (e.g., as set forth in U.S. patent application Ser. No. 18/991,853, filed on Dec. 23, 2024, which is incorporated by reference herein in its entirety).

A model inference generated by control plane 108 may include recommended parameters for deployment of a model, including a model family, quantization level, quantization type, model size, deployment technique (e.g., target compute node 102), and/or any other suitable parameters for the redeployed model. Based on the model inference, an orchestrator, auto-scaler, or other component of control plane 108 may migrate one or more workloads.

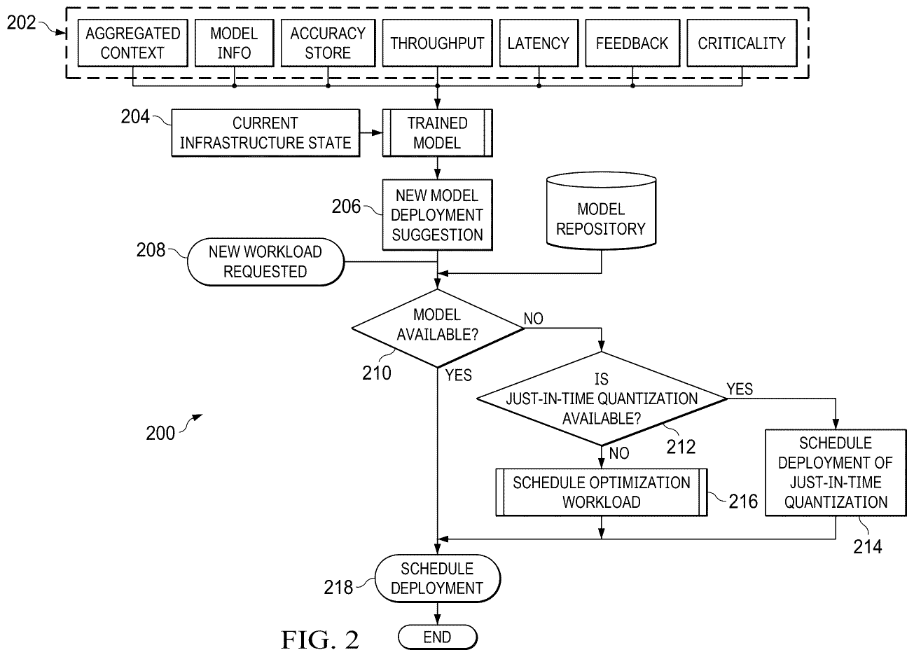

FIG. 2 illustrates a flow chart of an example method 200 for context-aware artificial intelligence workload deployment, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, a trained model implemented by control plane 108 may receive classic metrics regarding an artificial intelligence model and system 100 as well as contextual information regarding the artificial intelligence model and system 100. Such metrics and information may include aggregated contextual information, information regarding the artificial intelligence model (e.g., quantization of the model, parameter count of the model, name of the model, etc.), an accuracy score for the model, throughput of the model, latency of the model, feedback related to the model (e.g., user prompts and inference responses of the model), and a criticality of the model. At step 204, the trained model may also receive information regarding a current infrastructure state of system 100 (e.g., silicon architecture of system 100, such as identities of compute nodes 102 having central processing units, graphics processing units, neural processing units, etc.).

At step 206, based on the inputs received in the foregoing steps, the trained model of control plane 108 may generate a new model deployment suggestion for new workloads requested in system 100.

At step 208, a user may request a new artificial intelligence workload. At step 210, in response to the request, and based on the new model deployment suggestion and a model repository of available models for system 100, control plane 108 may determine if a model compliant with the new model deployment suggestion is available. If such a model is available, method 200 may proceed to step 218. Otherwise, method 200 may proceed to step 212.

At step 212, in response to unavailability of a model compliant with the new model deployment suggestion, control plane 108 may determine if a just-in-time quantization of the model is available. If a just-in-time quantization is available, method 200 may proceed to step 214. Otherwise, method 200 may proceed to step 216.

At step 214, control plane 108 may deploy the just-in-time quantization of the model as a stop gap until the optimized model compliant with the new model deployment suggestion is available.

At step 216, control plane 108 may schedule an optimization task to optimize the model in accordance with the new model deployment suggestion. To schedule the optimization task, control plane 108 may attempt to find an optimal window of time to perform the optimization task to avoid context switching. If there are no available resources, an orchestrator of control plane 108 may look for opportunities to deploy an optimized version of a second model to make room for the optimization task. Once there is room, control plane 108 may deploy the optimization workload. If the optimization task suddenly requires more capacity, control plane 108 may pause the optimization task and persist the model to continue the work later. Once the optimization is complete and the model is persisted, any workloads modified in order to enable the optimization may be restored. Once the optimization has completed, method 200 may proceed to step 218.

At step 218, control plane 108 may schedule deployment of the optimized model (i.e., whether already present in the model repository or newly generated optimized model). After completion of step 218, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of system 100 and/or any other system operable to implement method 200. In certain embodiments, method 200 may be implemented partially or fully in software and/or firmware embodied in computer-readable media.

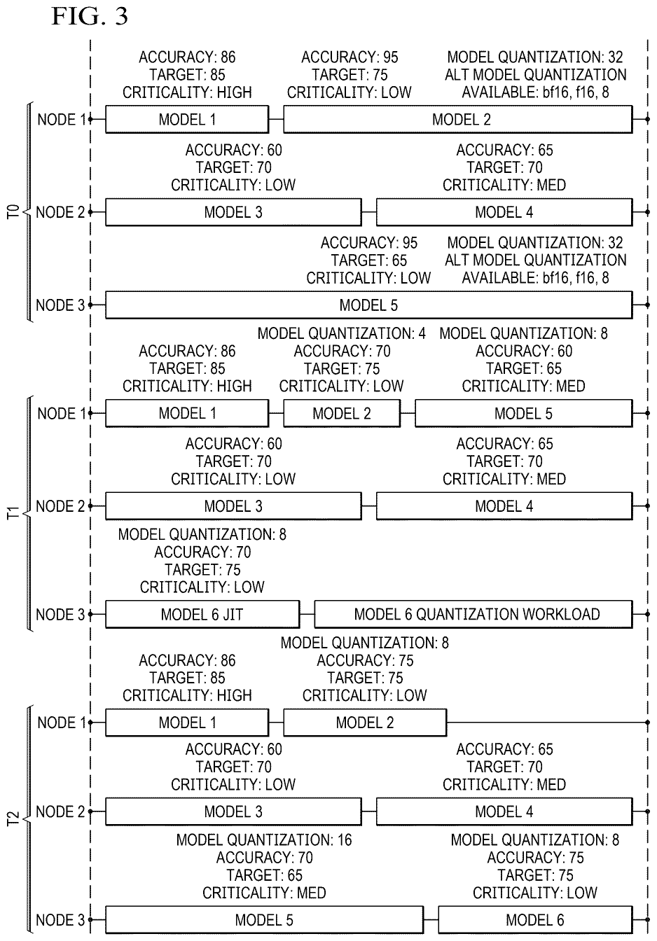

FIGS. 3-6 each illustrate a timing diagram of an example allocation of memory footprints of artificial intelligence workloads across three compute nodes, in accordance with embodiments of the present disclosure. FIGS. 3-6 each depict application of the systems and methods described above to example use cases.

For example, FIG. 3 depicts handling of a request, made at a time between time T0 and time T1, for a new Model 6. In response, control plane 108 may at time T1 deploy a just-in-time (JIT) quantized version of the requested model by moving or quantizing Model 2 and Model 5, and adding a quantization workload for Model 6. At time T2, once the quantization workload is complete, control plane 108 may deploy Model 6 and may rebalance Models 2 and 5 to improve accuracy.

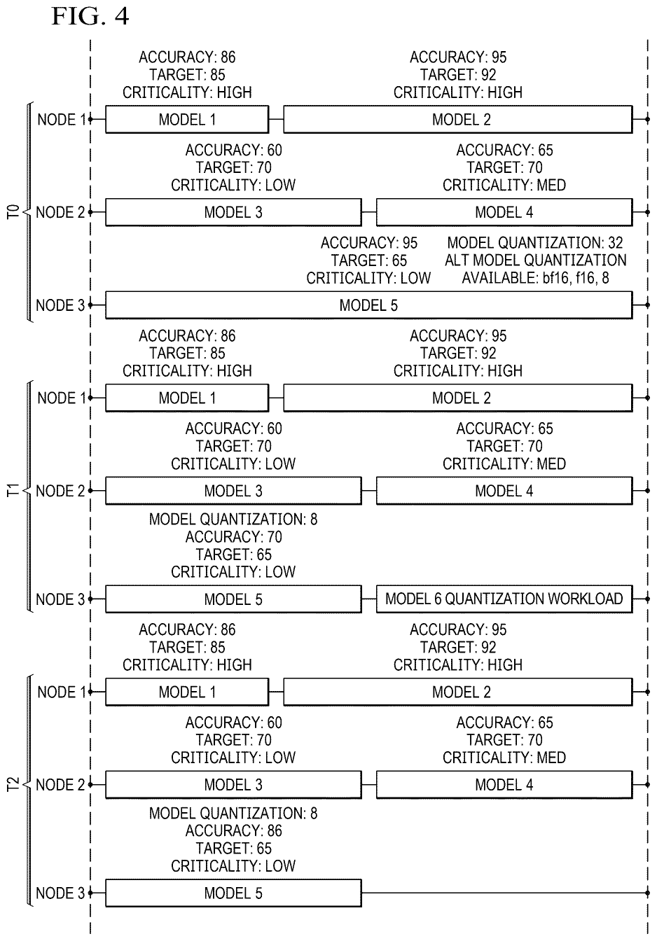

As another example, FIG. 4 depicts handling of a request, made at a time between time T0 and time T1 by an information technology decision maker, for a new model at a future time. Because the model may need to be quantized for future deployments, control plane 108 may schedule workloads to do so. At time T1, control plane 108 may temporarily add quantization of Model 6 to system 100 by reducing the memory footprint of Model 5 and continuing the workload for quantization of Model 6 until complete. At time T2, at which the workload for quantization of Model 6 is complete, control plane 108 may leave the memory footprint of Model 5 unchanged, as there may be no reason to increase such footprint.

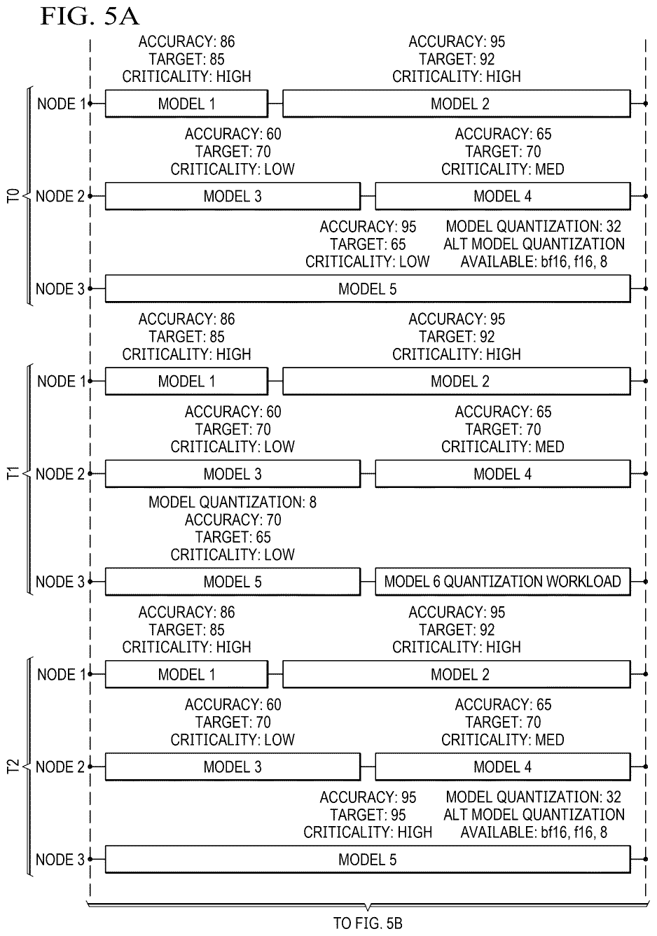

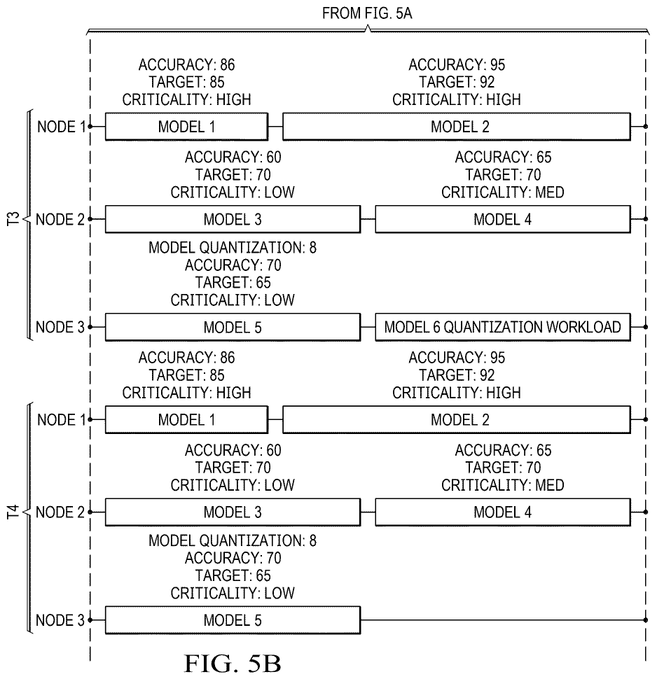

As an additional example, FIG. 5 depicts handling of a request, made at a time between time T0 and time T1 by an information technology decision maker, for a new model at a future time, similar to that of FIG. 4. However, in the example of FIG. 5, at time T2, Model 5 switches to a high criticality and thus requires higher accuracy. Accordingly, control plane 108 may remove the workload for quantization of Model 6 at time T2, until a future time T3 in which Model 5 is no longer of high priority.

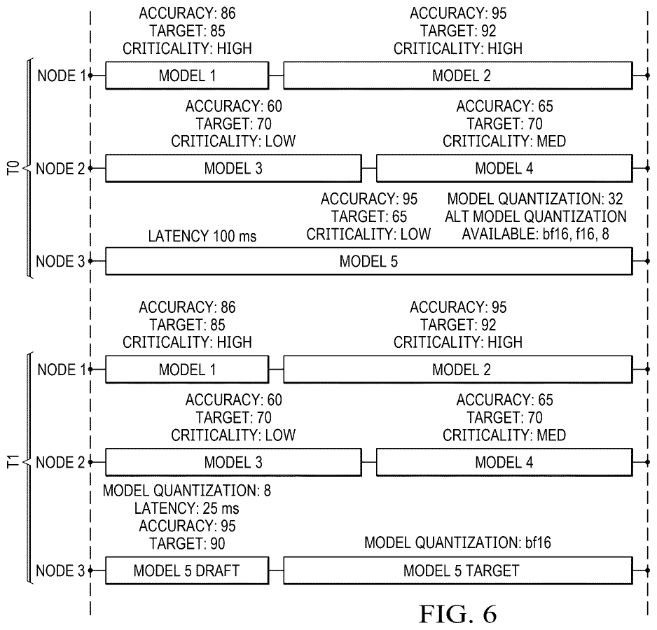

As a further example, FIG. 6 depicts deploying of speculative decoding of Model 5 at a time T1. Speculative decoding is a known deployment technique, but may be used as one or many approaches to improve metrics based on context.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to:
collect contextual information associated with a first artificial intelligence model executing on a compute node; and
execute a second artificial intelligence model to generate a new model deployment suggestion inference for the first artificial intelligence model based at least on the contextual information, the new model deployment suggestion inference setting forth parameters for a redeployment of the first artificial intelligence model.

2. The information handling system of claim 1, the processor further configured to:
in response to a request for a workload for execution on the first artificial intelligence model, determine if a new model compliant with the new model deployment suggestion inference is available; and
schedule deployment of the new model if the new model is available.

3. The information handling system of claim 1, the processor further configured to:
in response to a request for a workload for execution on the first artificial intelligence model, determine if a new model compliant with the new model deployment suggestion inference is available;
schedule an optimization workload for optimizing the first artificial intelligence model to generate the new model; and
schedule deployment of the new model upon completion of the optimization workload.

4. The information handling system of claim 3, the processor further configured to:
in response to a request for a workload for execution on the first artificial intelligence model, determine if a just-in-time quantization of the first artificial intelligence model is available; and
schedule deployment of the just-in-time quantization if the just-in-time quantization is available for execution until the optimization workload is complete.

5. The information handling system of claim 1, wherein the contextual information comprises one or more of a model size of the first artificial intelligence model, silicon architecture of a system comprising the compute node, user feedback associated with the first artificial intelligence model, and execution context of the first artificial intelligence model.

6. The information handling system of claim 1, wherein the parameters for deployment comprise one or more of a model family, a quantization level, a quantization type, a model size, and a deployment technique.

7. A method comprising:
collecting contextual information associated with a first artificial intelligence model executing on a compute node; and
executing a second artificial intelligence model to generate a new model deployment suggestion inference for the first artificial intelligence model based at least on the contextual information, the new model deployment suggestion inference setting forth parameters for a redeployment of the first artificial intelligence model.

8. The method of claim 7, further comprising:
in response to a request for a workload for execution on the first artificial intelligence model, determine if a new model compliant with the new model deployment suggestion inference is available; and
schedule deployment of the new model if the new model is available.

9. The method of claim 7, further comprising:
in response to a request for a workload for execution on the first artificial intelligence model, determine if a new model compliant with the new model deployment suggestion inference is available;
schedule an optimization workload for optimizing the first artificial intelligence model to generate the new model; and
schedule deployment of the new model upon completion of the optimization workload.

10. The method of claim 9, further comprising:
in response to a request for a workload for execution on the first artificial intelligence model, determine if a just-in-time quantization of the first artificial intelligence model is available; and
scheduling deployment of the just-in-time quantization if the just-in-time quantization is available for execution until the optimization workload is complete.

11. The method of claim 7, wherein the contextual information comprises one or more of a model size of the first artificial intelligence model, silicon architecture of a system comprising the compute node, user feedback associated with the first artificial intelligence model, and execution context of the first artificial intelligence model.

12. The method of claim 7, wherein the parameters for deployment comprise one or more of a model family, a quantization level, a quantization type, a model size, and a deployment technique.

13. An article of manufacture comprising:
a non-transitory computer-readable medium; and
computer-executable instructions carried on the computer-readable medium, the instructions readable by a processor, the instructions, when read and executed, for causing the processor to:
collect contextual information associated with a first artificial intelligence model executing on a compute node; and
execute a second artificial intelligence model to generate a new model deployment suggestion inference for the first artificial intelligence model based at least on the contextual information, the new model deployment suggestion inference setting forth parameters for a redeployment of the first artificial intelligence model.

14. The article of claim 13, the instructions for further causing the processor to:
in response to a request for a workload for execution on the first artificial intelligence model, determine if a new model compliant with the new model deployment suggestion inference is available; and
schedule deployment of the new model if the new model is available.

15. The article of claim 13, the instructions for further causing the processor to:
in response to a request for a workload for execution on the first artificial intelligence model, determine if a new model compliant with the new model deployment suggestion inference is available;
schedule an optimization workload for optimizing the first artificial intelligence model to generate the new model; and
schedule deployment of the new model upon completion of the optimization workload.

16. The article of claim 15, the instructions for further causing the processor to:
in response to a request for a workload for execution on the first artificial intelligence model, determine if a just-in-time quantization of the first artificial intelligence model is available; and
schedule deployment of the just-in-time quantization if the just-in-time quantization is available for execution until the optimization workload is complete.

17. The article of claim 13, wherein the contextual information comprises one or more of a model size of the first artificial intelligence model, silicon architecture of a system comprising the compute node, user feedback associated with the first artificial intelligence model, and execution context of the first artificial intelligence model.

18. The article of claim 13, wherein the parameters for deployment comprise one or more of a model family, a quantization level, a quantization type, a model size, and a deployment technique.
